(19) United States
(12) Patent Application Publication
(10) Pub. No.: US 2013/0308268 A1
(43) Pub. Date: Nov. 21, 2013

(54) INFORMATION PROCESSING APPARATUS

(71) Applicant: SONY CORPORATION, Tokyo (JP)

(72) Inventor: Atsushi Tani, Nagano (JP)

(73) Assignee: SONY CORPORATION, Tokyo (JP)

(21) Appl. No.: 13/888,642

(22) Filed: May 7, 2013

(30) Foreign Application Priority Data
May 16, 2012 (JP) 2012-112072

(51) Int. Cl. G06F 1/16

(52) U.S. Cl. CPC G06F 1/1681; G06F 1/1679
USPC 361/679.57; 361/679.02

(57) ABSTRACT

A hinge portion connects between first and second casings. The second casing includes a thickness direction along a first axis direction. The hinge portion supports the first casing with respect to the second casing to be rotatable between a first state in which the hinge portion is opposed to the second casing and a second state in which the hinge portion is rotated around a second axis orthogonal to the first axis direction by a predetermined angle. A connection module is provided in the second casing and is electrically connectable to an external apparatus in the second state. A conversion mechanism is provided between the first and second casings and converts a thickness of the connection module along the first axis direction from a first thickness into a second, larger thickness in conjunction with rotation of the first casing from the first state to the second state.

### BACKGROUND

The present disclosure relates to an information processing apparatus such as a laptop personal computer.

In recent years, in an information processing apparatus typified by a laptop personal computer, a casing has become smaller in size and thickness for the purpose of enhancing portability. On the other hand, the information processing apparatus of this kind includes a plurality of connection terminals (connector jacks) to an external apparatus. It is desirable to achieve a further reduction in size and thickness of the apparatus by devising configurations of those connection terminals.

For example, Japanese Patent Application Laid-open No. 2001-338714 (hereinafter, referred to as Patent Document 1) discloses the following electronic apparatus. The electronic apparatus includes an electrical connection portion configured to be connectable to an external electrical connection terminal. The electronic apparatus is capable of switching between a state in which the electrical connection portion is housed in a casing and a state in which the electrical connection portion is exposed to an outside of the casing.

### SUMMARY

However, in the electronic apparatus described in Patent Document 1, it is necessary to switch between the housing and the exposure of the electrical connection portion by a manual operation of a user, which makes a connection operation to an external apparatus cumbersome. Further, the electrical connection portion does not change in thickness or height both in the housing state and the exposed state. Thus, it is difficult to realize a further reduction in thickness of the casing.

In view of the above-mentioned circumstances, it is desirable to provide an information processing apparatus capable of realizing a reduction in thickness of a casing without deteriorating connection operability to an external apparatus.

According to an embodiment of the present disclosure, there is provided an information processing apparatus including a first casing, a second casing, a hinge portion, at least one connection module, and a conversion mechanism.

The second casing includes a thickness direction along a first axis direction.

The hinge portion is configured to connect between the first casing and the second casing and support the first casing with respect to the second casing to be rotatable between a first state in which the hinge portion is opposed to the second casing and a second state in which the hinge portion is rotated around a second axis orthogonal to the first axis direction by a predetermined angle.

The connection module is provided in the second casing and configured to be electrically connectable to an external apparatus in the second state.

The conversion mechanism is provided between the first casing and the second casing. The conversion mechanism is configured to convert a thickness of the connection module along the first axis direction from a first thickness into a second thickness larger than the first thickness in conjunction with rotation of the first casing from the first state to the second state.

The information processing apparatus includes a first state in which the first casing is closed with respect to the second casing and a second state in which the first casing is opened with respect to the second casing. The first casing is opened and closed with respect to the second casing via the hinge portion. In conjunction with rotation of the first casing from the first state to the second state, the connection module is converted from the first thickness into the second thickness, such that the connection module can be connected to the external apparatus. Therefore, according to the information processing apparatus, the connection module can be automatically switched to a usable state during a rotation operation of the first casing. Thus, a switching operation of the connection module by the user becomes unnecessary. With this, connection operability to the external apparatus can be prevented from being deteriorated. Further, the thickness of the connection module can be reduced in the first state, and hence a reduction in thickness of the second casing can be realized.

The connection module is configured to take a first posture in which the connection module is opposed to the second casing when the connection module has the first thickness, and a second posture in which the connection module is exposed to an outside of the second casing when the connection module has the second thickness.

The conversion mechanism may include a link mechanism portion and a transmission member. The link mechanism portion is configured to convert the connection module from the first posture into the second posture. The transmission member is provided between the first casing and the link mechanism portion and configured to transmit rotation operation force of the first casing from the first state to the second state, to the link mechanism portion.

With this, the posture of the connection module can be changed by driving of the link mechanism portion.

The link mechanism portion may include a base plate, a coupling plate, and a guide portion. The base plate includes a first fulcrum coupled to the second casing, and is configured to support the connection module. The coupling plate includes a second fulcrum coupled to the second casing and a third fulcrum coupled to the base plate. The guide portion is attached to the second casing, and configured to guide a movement of the first fulcrum relative to the second fulcrum during conversion from the first posture into the second posture.

The conversion mechanism may further include a lock member and a return member. The lock member is attached to the second casing and is configured to be capable of retaining the first fulcrum in the second posture. The return member is attached between the first fulcrum and the second fulcrum and configured to bias the connection module in a direction to return the connection module to the first posture.

With this, also after the first casing rotates from the second state to the first state, the second posture of the connection module can be maintained and a connection state between the connection module and the external apparatus can be maintained.

The second casing may include a housing portion capable of housing the connection module. The connection module may be configured to be opposed to an inner surface of the housing portion when the connection module takes the first posture, and exposed to an outside of the housing portion when the connection module takes the second posture. With this, the connection module that takes the first posture can be compactly housed.

The second casing may include a back portion to be connected to the hinge portion. The housing portion may be provided in the back portion.

For example, the connection module may be a local area network (LAN) module, a video graphics array (VGA) module, or a connection module other than those modules. Alternatively, the connection module may include a plurality of connection modules.

The connection module may include an internal terminal, a four-joint link mechanism, and an elastic material. The internal terminal is configured to be movable between a stand-by position at which the internal terminal is disconnected to the external apparatus and an attachment position at which the internal terminal is connected to the external apparatus. The four-joint link mechanism is configured to be connected to the connection module by being pressed by the external apparatus, such that the internal terminal moves from the stand-by position to the attachment position. The elastic member is configured to bias the four-joint link mechanism in a direction to return the internal terminal to the stand-by position.

Alternatively, the connection module may include an internal terminal, a guide mechanism, and a biasing member. The internal terminal is configured to be movable between a stand-by position at which the internal terminal is disconnected to the external apparatus and an attachment position at which the internal terminal is connected to the external apparatus. The guide mechanism is configured to be connected to the connection module by being pressed by the external apparatus, such that the internal terminal moves from the stand-by position to the attachment position. The biasing member is configured to bias the guide mechanism in a direction to return the internal terminal to the stand-by position.

The information processing apparatus may further include a screen provided in the first casing, and an input operation surface provided in the second casing. Examples of the information processing apparatus include a laptop personal computer, a cell phone, an electronic dictionary, and a portable game console.

As mentioned above, according to the embodiment of the present disclosure, a reduction in thickness of a casing can be realized without deteriorating connection operability to an external apparatus.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a right side view showing a first state of an information processing apparatus according to an embodiment of the present disclosure;

FIG. 2 is a right side view showing a second state of the information processing apparatus;

FIG. 3 is a perspective view as viewed from a back side of the information processing apparatus showing a mode in the first state;

FIG. 4 is a perspective view as viewed from the back side of the information processing apparatus in the second state;

FIG. 5 is a cross-sectional perspective view of main parts showing a configuration of a conversion mechanism of the information processing apparatus;

FIGS. 6A to 6C are schematic side views of main parts of the information processing apparatus for explaining a configuration and an action of the conversion mechanism;

FIG. 7 is a model view of a configuration of a link mechanism portion constituting the conversion mechanism;

FIG. 8 is a longitudinal sectional view showing a mode (first mode) of a connection module before the connection module is connected to the external apparatus;

FIG. 9 is a longitudinal sectional view showing a mode in the connection module during a process in which the connection module is connected to the external apparatus;

FIG. 10 is a longitudinal sectional view showing a mode (second mode) of the connection module after the connection module is connected to the external apparatus;

FIG. 11 is a perspective view showing the second mode of the connection module;

FIGS. 12A and 12B are cross-sectional views taken along a line [A]-[A] direction and a line [B]-[B] direction in FIG. 11;

FIG. 13 is a perspective view showing a configuration of a different connection module and configurations at the periphery of the different connection module;

FIG. 14 is a cross-sectional view taken along a line [C]-[C] direction in FIG. 13;

FIG. 15 is a cross-sectional view showing a mode (first mode) of the different connection module before the different connection module is connected to the external apparatus;

FIG. 16 is a cross-sectional view of main parts showing a mode of the different connection module during a process in which the different connection module is connected to the external apparatus;

FIG. 17 is a longitudinal sectional view showing a mode (second mode) of the different connection module after the different connection module is connected to the external apparatus;

FIG. 18 is a perspective view of the different connection module alone;

FIG. 19 is a perspective view of one member constituting the different connection module;

FIG. 20 is a cross-sectional view taken along a line [D]-[D] direction in FIG. 18; and

FIG. 21 is a perspective view as viewed from the back side of the information processing apparatus showing a different mode in the first state.

### DETAILED DESCRIPTION OF EMBODIMENTS

Hereinafter, an embodiment according to the present disclosure will be described with reference to the drawings. In this embodiment, a description will be made by exemplifying a laptop personal computer as an information processing apparatus.

### [Configuration of Information Processing Apparatus]

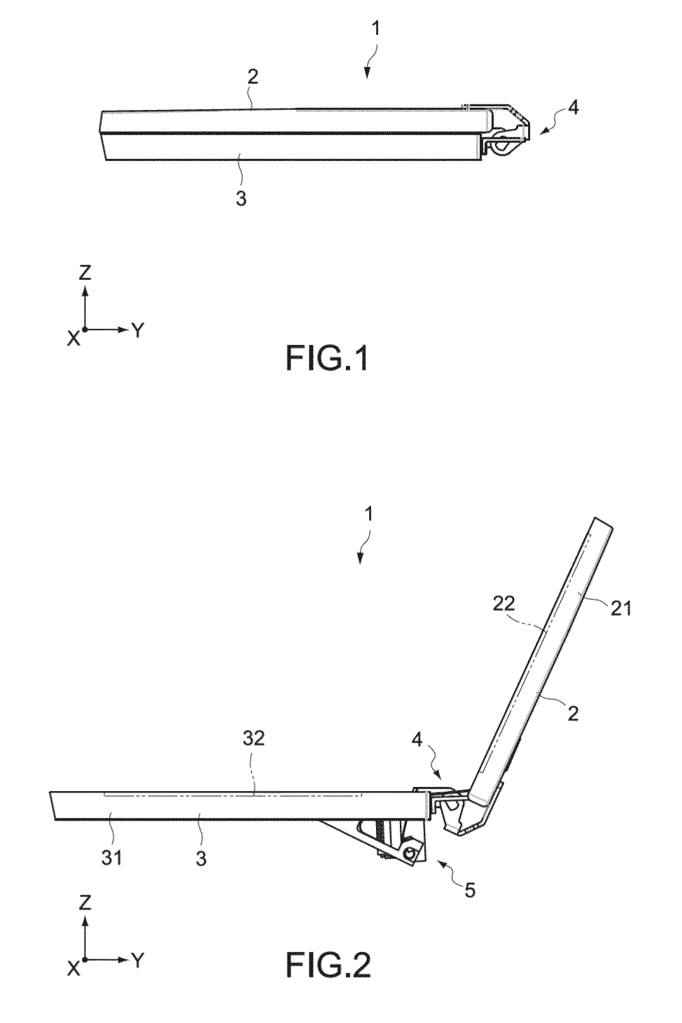

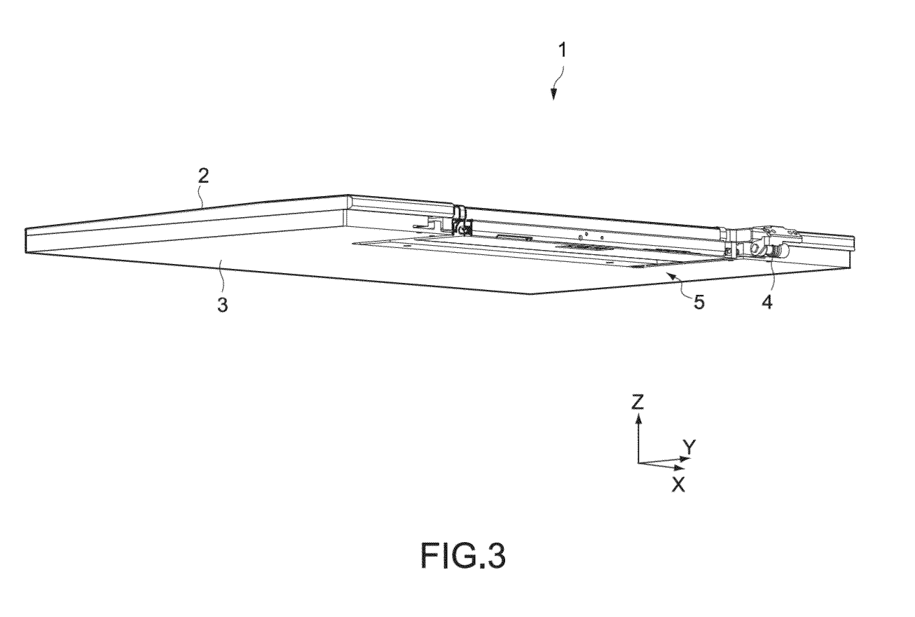

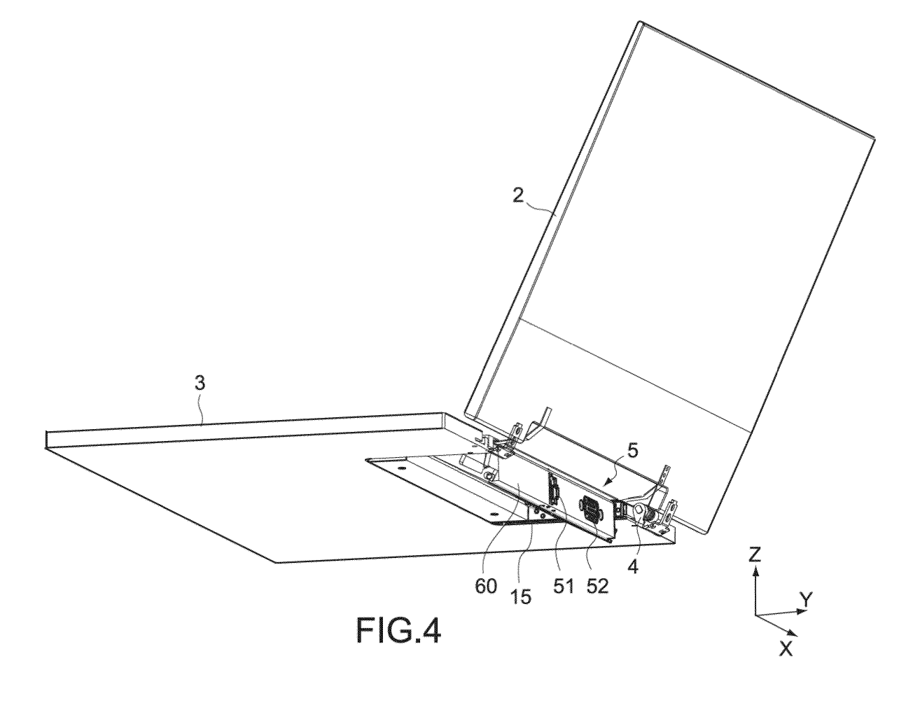

FIGS. 1 to 4 are outer appearance views of an information processing apparatus according to an embodiment of the present disclosure. FIG. 1 is a right side view when a display portion 2 (first casing) of an information processing apparatus 1 covers a top surface of a main body portion 3 (second casing) (hereinafter, also referred to as “first state”). FIG. 2 is a right side view when the display portion is opened with respect to the main body portion 3 (hereinafter, also referred to as “second state”). FIG. 3 is a perspective view as viewed from the back side of the information processing apparatus 1 in the first state. FIG. 4 is a perspective view as viewed from the back side of the information processing apparatus 1 in the second state. Here, left- and right-hand directions are orientations as viewed from a user who uses the information processing apparatus 1, and correspond to an X-axis direction in the figures. Note that, in the figures, a Y-axis direction indicates front and rear directions of the information processing apparatus 1 and a Z-axis direction indicates a thickness direction of the information processing apparatus 1.

The information processing apparatus 1 includes the display portion 2, the main body portion 3, a hinge portion 4 that couples the display portion 2 and the main body portion 3 to be rotatable, and an external connection portion 5.

The display portion 2 includes a casing 21 (first casing) and a display panel 22 (screen) provided in the casing 21. The display panel 22 includes, for example, a liquid crystal display (LCD) and an organic electro luminescence (EL) panel. The display panel 22 may include a touch panel.

The main body portion 3 includes a casing 31 (second casing) and an input operation surface 32 provided in a top surface of the casing 31. The input operation surface is provided with an input member such as a touch pad portion and a keyboard unit. The casing 31 incorporates a group of hardware components necessary for configuring a computer, such as a central processing unit (CPU)/micro processing unit (MPU), a main memory, a storage apparatus, and a motherboard. Examples of the storage apparatus include a hard disk drive (HDD) and a solid-state drive (SSD).

The hinge portion 4 connects between the display portion 2 and the main body portion 3. The hinge portion 4 supports the display portion 2 with respect to the main body portion 3 to be rotatable between a first state in which the display portion 2 is opposed to the main body portion 3 and a second state in which the display portion 2 is rotated around an X-axis by a predetermined angle. The display portion 2 in the second state is set at an arbitrary angle such that the top surface (input operation surface) of the main body portion 3 is opened and the display panel 22 of the display portion 2 is erected at an optimal angle as viewed from the user. The hinge portions 4 are attached at two positions in a back surface of the information processing apparatus 1 at an appropriate interval.

The external connection portion 5 includes at least one connection module configured to be electrically connectable to the external apparatus. The external apparatus includes not only an apparatus main body but also a cable system that connects between the external apparatus and the information processing apparatus 1. Examples of the external apparatus include an electronic apparatus such as a printer, a monitor, a projector, a router, a hub, a personal computer, a camera, a video camera, and a cell phone. Examples of the connection module include a connection port or a connector jack of various modules such as a video graphics array (VGA), a local area network (LAN), a universal serial bus (USB), and a high-definition multimedia interface (HDMI).

Hereinafter, the external connection portion 5 will be described in detail.

### [External Connection Portion]

In this embodiment, the external connection portion includes a LAN module 51 and a VGA module 52 as the connection modules, and a base plate 60. The base plate 60 commonly supports those two connection modules (hereinafter, collectively referred to as connection modules 51 and 52 except for the case where they are individually described). The base plate 60 is formed of a rectangular plate-like member including a longitudinal direction in the X-axis direction. The connection modules 51 and 52 are provided at predetermined positions of the base plate 60.

The external connection portion 5 is provided on the back side of the main body portion 3 between two hinge portions 4 in this embodiment. At the bottom of the main body portion 3 on the back side, a housing portion 15 capable of housing the external connection portion 5 is provided. The connection modules 51 and 52 are configured to be capable of switching between a posture in which the connection modules 51 and 52 are housed in the housing portion 15 (hereinafter, referred to as “first posture”) as shown in FIG. 3 and a posture in which the connection modules 51 and 52 are exposed to an outside of the housing portion 15 as shown in FIG. 4 (hereinafter, referred to as “second posture”).

In the first posture, the connection modules 51 and 52 are housed in the housing portion 15 and opposed to an inner surface of the housing portion 15 (main body portion 3) without being exposed to the outside. With this, it is possible to prevent adhesion and penetration of dust to/into the connection modules 51 and 52. Further, in the first posture, the base plate 60 lies down. The bottom of the base plate 60 forms part of the bottom of the main body portion 3. With this, the design of the main body portion 3 can be improved.

On the other hand, in the second posture, the connection modules 51 and 52 are exposed to the outside of the main body portion 3 to be connectable to the external apparatus. At this time, the base plate 60 rotates around the X-axis by a predetermined angle from the side-lying posture, and a lower end portion of the base plate 60 projects from the bottom of the main body portion 3.

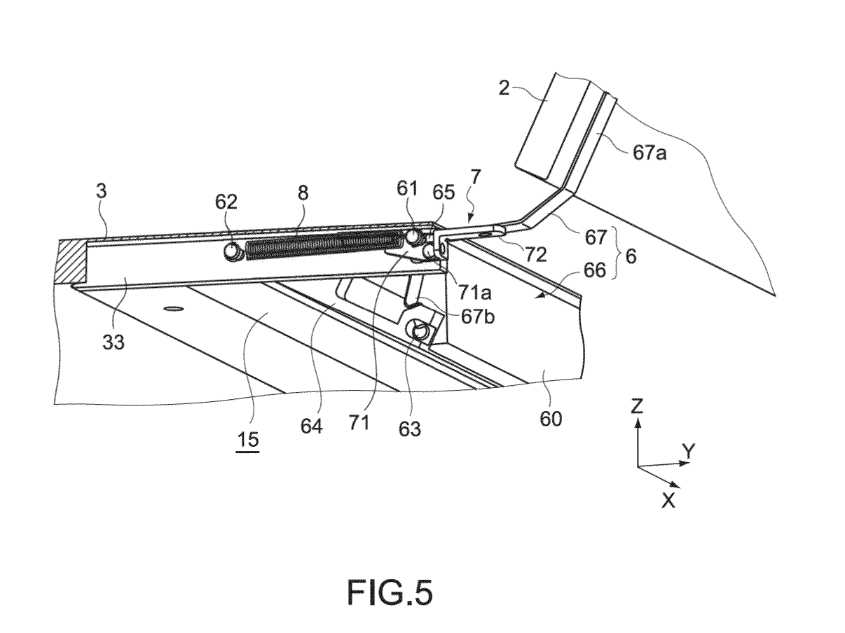

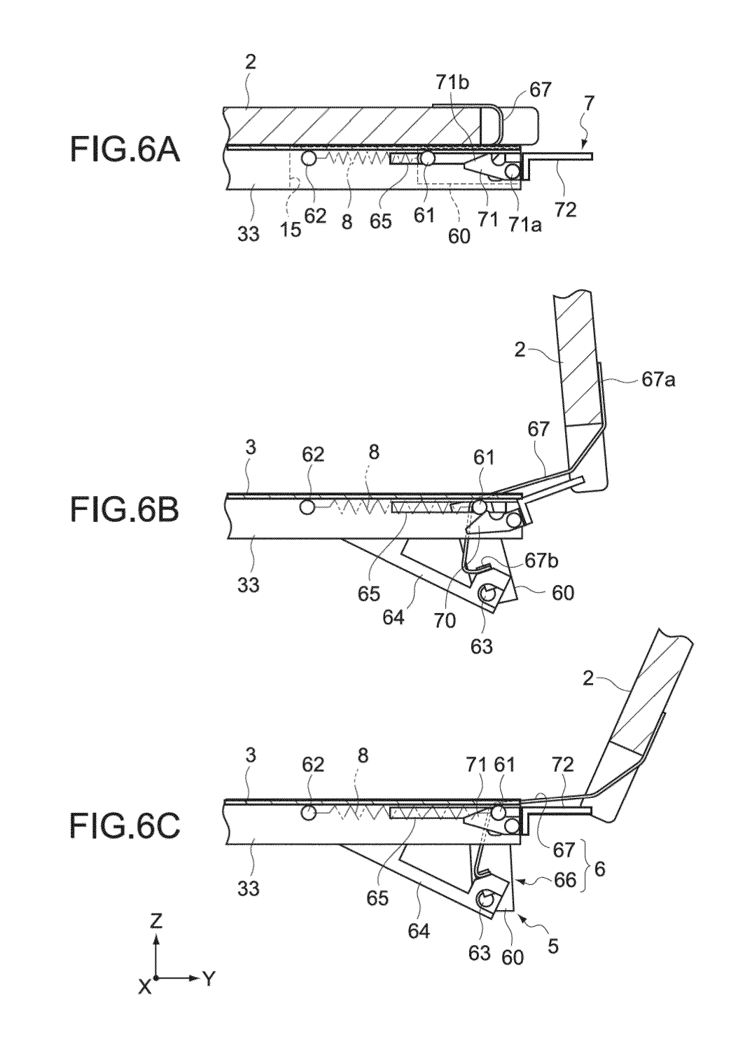

The information processing apparatus 1 includes a conversion mechanism 6 (FIGS. 5 and 6A to 6C) that switches between the first posture and the second posture of the connection modules 51 and 52. The conversion mechanism 6 is provided between the display portion 2 and the main body portion 3. The conversion mechanism 6 converts a thickness of the connection modules 51 and 52 along the Z-axis direction from a first thickness to a second thickness larger than the first thickness in conjunction with rotation of the display portion 2 from the first state to the second state.

Hereinafter, the conversion mechanism 6 and the connection modules 51 and 52 will be described in detail.

### (Conversion Mechanism)

FIG. 5 is a cross-sectional perspective view of main parts of the information processing apparatus 1 showing a configuration of the conversion mechanism 6. FIGS. 6A to 6C are schematic side views of main parts of the information processing apparatus 1 for explaining a configuration and an action of the conversion mechanism 6. FIG. 6A shows the display portion 2 in the first state. FIG. 6B shows a transition process of the display portion 2 from the first state to the second state. FIG. 6C shows the display portion 2 in the second state.

The conversion mechanism 6 includes a link mechanism portion 66 and a transmission member 67. The link mechanism portion 66 converts the connection modules 51 and 52 from the first posture into the second posture. The transmission member 67 is provided between the display portion 2 and the link mechanism portion 66. The transmission member 67 transmits rotation operation force of the display portion 2 from the first state to the second state, to the link mechanism portion 66.

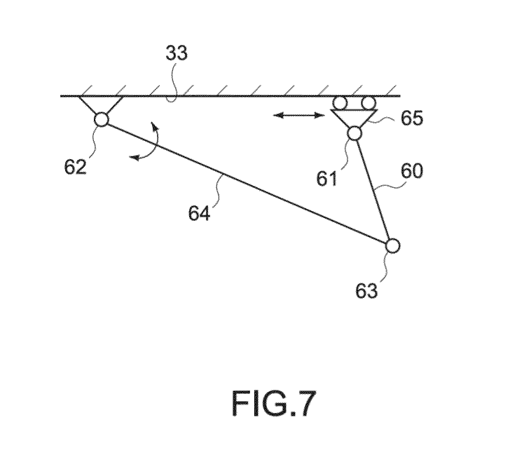

The link mechanism portion 66 includes the base plate 60, a coupling plate 64, and a guide portion 65. FIG. 7 is a model view showing a configuration of the link mechanism portion 66.

The base plate 60 includes a first fulcrum 61 coupled to a casing frame 33 integrated with the casing 31 of the main body portion 3. The first fulcrum 61 includes a shaft portion extending in the X-axis direction and supports the base plate 60 with respect to the casing frame 33 to be rotatable around the X-axis. The coupling plate 64 includes a second fulcrum 62 coupled to the casing frame 33 and a third fulcrum 63 coupled to the base plate 60. The second fulcrum and the third fulcrum 63 each include a shaft portion extending in the X-axis direction. The second fulcrum 62 and the third fulcrum 63 support the coupling plate 64 with respect to the casing frame 33 and the base plate 60 to be rotatable around the X-axis. The guide portion 65 is attached to the casing 31. The guide portion 65 guides a movement of the first fulcrum 61 relative to the second fulcrum 62 upon posture conversion from the first posture to the second posture.

In this embodiment, the guide portion 65 is formed of a rectangular cutout portion formed along the front and rear directions (Y-axis direction) in the casing frame 33. The guide portion 65 is inserted into the shaft portion of the second fulcrum 62. With this, the first fulcrum 61 is movable relative to the second fulcrum 62 in the front and rear directions of the casing 31.

The transmission member 67 is formed of an elastic material. In this embodiment, the transmission member 67 is formed of a plate spring bent in a predetermined shape. The transmission member 67 includes a first end portion 67a and a second end portion 67b. The first end portion 67a is fixed to the casing 21 of the display portion 2. The second end portion 67b is fixed near the third fulcrum 63 of the coupling plate 64. The transmission member 67 passes between the first fulcrum 61 and the second fulcrum 62. The end portions 67a and 67b of the transmission member 67 are fixed to the display portion 2 and the link mechanism portion 66, respectively.

In conjunction with rotation of the display portion 2 from the first state to the second state, the transmission member 67 presses the first fulcrum 61 to the back side of the casing 31 and drives the link mechanism portion 66. By driving of the link mechanism portion 66, the first fulcrum 61 moves from a position shown in FIG. 6A (hereinafter, referred to as “first position”) to the back side of the casing 31 along the guide portion 65, and the base plate 60 rotates around the first fulcrum 61 in a clockwise direction in the figure (FIG. 6B). When the display portion 2 reaches the second state, the second fulcrum 62 stops at a position shown in FIG. 6C (hereinafter, referred to as “second position”), and the base plate 60 is maintained in a posture in which the base plate 60 is erected almost in a perpendicular direction with respect to the main body portion 3 (FIG. 6C).

In the above-mentioned manner, the connection modules 51 and 52 are converted from the first posture in which the connection modules 51 and 52 are housed in the housing portion 15 to the second posture in which the connection modules 51 and 52 are exposed to the outside of the main body portion 3. In this embodiment, the connection modules 51 and 52 are commonly supported by the base plate 60. Therefore, the entire external connection portion 5 including the connection modules 51 and 52 and the base plate 60 is converted by the conversion mechanism 6 from the first posture into the second posture.

The above-mentioned conversion mechanisms 6 are provided on both end sides of the external connection portion 5 in the longitudinal direction. With this, it is possible to ensure smooth posture conversion of the external connection portion 5. Note that, although the conversion mechanism 6 is not limited thereto, the conversion mechanism 6 may be provided on only one end side of the external connection portion 5 in the longitudinal direction.

The information processing apparatus 1 according to this embodiment further includes a retaining member 7 capable of maintaining the second posture of the connection modules 51 and 52, and a return member 8 that returns the connection modules 51 and 52 to the first posture (FIGS. 5 and 6A to 6C).

The retaining member 7 includes a lock piece 71 attached to the main body portion 3 (casing frame 33) to be rotatable. The lock piece 71 includes a rotating shaft 71a provided on one end side and a wedge portion 71b formed on the other end side that is opposed to the first fulcrum 61. The retaining member 7 further includes a torsion spring (omitted in the figure) attached around the rotating shaft 71a. The lock piece 71 is biased by the torsion spring to a lock position shown in FIG. 6A. Then, as shown in FIGS. 6B and 6C, the lock piece 71 rotates in a counter-clockwise direction in the figures due to contact between the first fulcrum 61 and the wedge portion 71b that moves the back side of the main body portion 3. When the first fulcrum 61 reaches the second position at which the first fulcrum 61 climbs over the wedge portion 71b, the first fulcrum 61 returns to a lock position due to biasing of the torsion spring.

The return member 8 is attached between the first fulcrum 61 and the second fulcrum 62 and biases the connection modules 51 and 52 in a direction to return the connection modules 51 and 52 to the first posture. In this embodiment, the return member 8 is formed of a coil spring. The coil spring is, at both ends thereof, fixed to the first fulcrum 61 and the second fulcrum 62. The return member 8 biases the first fulcrum 61 in a direction to attract the first fulcrum 61, which has been moved to the lock position, toward the second fulcrum 62. The lock piece 71 retains the first fulcrum 61 at the second position against biasing force of the return member 8.

On the other hand, the retaining member 7 further includes a lock-release piece 72. The lock-release piece 72 is integrally attached to the lock piece 71. In order to return the connection modules 51 and 52 to the first posture, the lock piece 71 of the lock-release piece 72 is rotationally operated from the lock position to an unlock position. By the rotation operation of the lock-release piece 72, the first fulcrum 61 returns from the second position to the first position due to the biasing force of the return member 8. With this, the connection modules 51 and 52 (external connection portion 5) return from the second posture to the first posture.

The retaining member 7 and the return member 8 described above are provided on only one end side of the external connection portion 5 in the longitudinal direction. However, the retaining members 7 and the return members 8 may be provided on the both end sides of the external connection portion 5 in the longitudinal direction.

### (LAN Module)

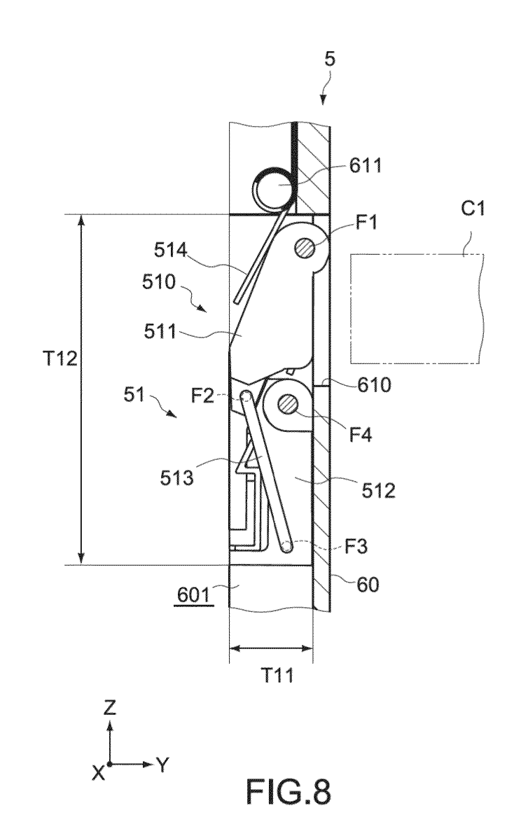

Next, the LAN module 51 will be described. FIGS. 8 to 10 are cross-sectional views of main parts showing a mode change before and after connection with the external apparatus of the LAN module 51 that takes the second posture.

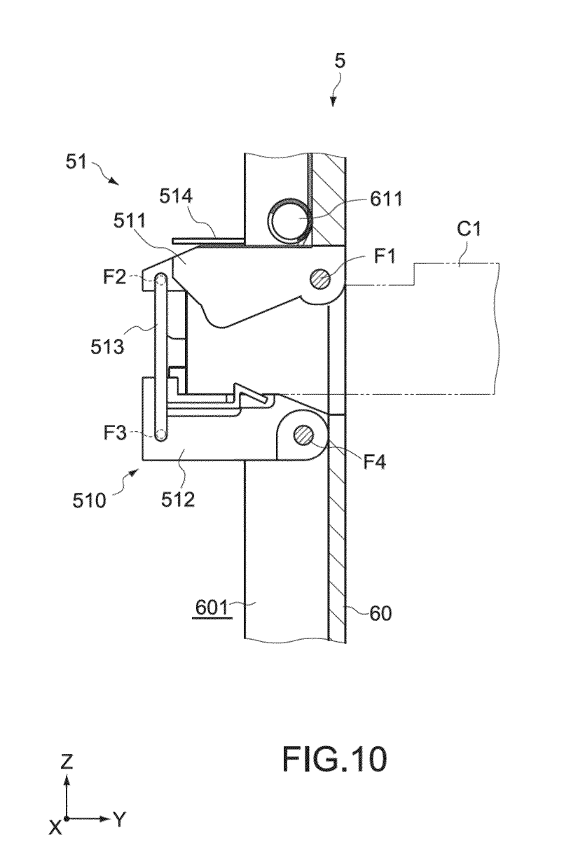

FIG. 8 is a longitudinal sectional view showing a mode of the LAN module 51 before the LAN module 51 is connected to a cable member C1 (external apparatus) (hereinafter, referred to as “first mode”). FIG. 10 is a longitudinal sectional view showing a mode of the LAN module 51 after the LAN module 51 is connected to the cable member C1 (hereinafter, referred to as “second mode”). As shown in FIGS. 8 and 10, the LAN module 51 includes different modes before and after the connection with the cable member C1. During non-use, as shown in FIG. 8, the LAN module 51 is folded in the Y-axis direction.

As shown in FIG. 8, during non-use, the LAN module includes a first component size T11 along the Y-axis direction and a second component size T12 along the Z-axis direction. As shown in the figure, T11 is smaller than T12. When the LAN module 51 takes the first posture, T11 becomes a thickness dimension along the Z-axis direction. When the LAN module 51 takes the second posture, T12 becomes a thickness dimension along the Z-axis direction. Therefore, in conjunction with rotation of the display portion 2 from the first state to the second state, a thickness of the LAN module 51 along the Z-axis direction is converted by the conversion mechanism 6 from the first thickness (T11) into the second thickness (T12) larger than the first thickness.

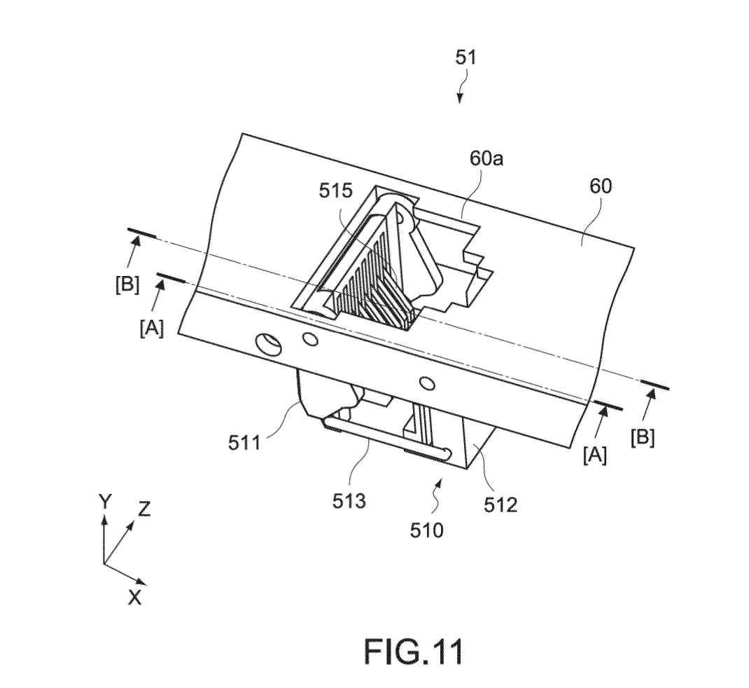

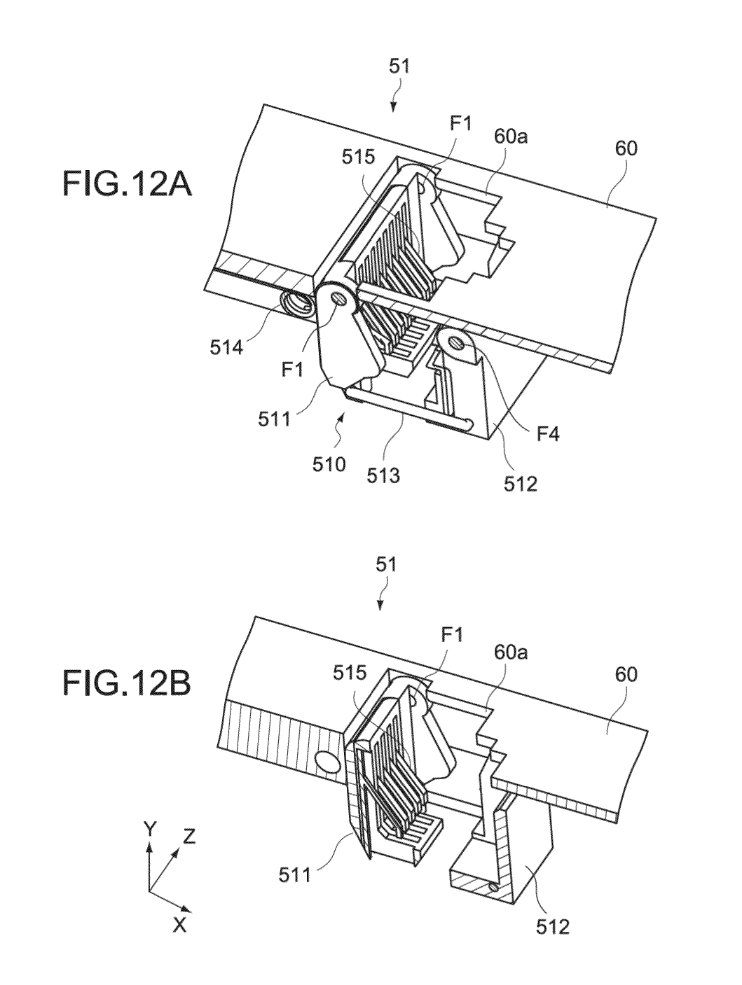

FIG. 11 is a perspective view showing the second mode of the LAN module 51. FIGS. 12A and 12B are cross-sectional views taken along a line [A]-[A] direction and a line [B]-[B] direction in FIG. 11, respectively. Note that the cable member C1 is omitted in each figure.

The LAN module 51 is provided in a space portion 601 formed inside the base plate 60. The LAN module 51 is connected to the cable member C1 via a first attachment hole 60a having a predetermined shape formed in a main surface of the base plate 60. The LAN module 51 includes an internal terminal 515, a four-joint link mechanism 510, and an elastic member 514.

The internal terminal 515 is configured to be movable between a stand-by position at which the internal terminal 515 is disconnected to the cable member C1 and an attachment position at which the internal terminal 515 is connected to the cable member C1. Here, the stand-by position corresponds to the first mode of the LAN module 51, and the attachment position corresponds to the second mode of the LAN module 51. The internal terminal 515 is supported by the four-joint link mechanism 510. The internal terminal 515 moves from the stand-by position to the attachment position by driving of the four-joint link mechanism 510.

The four-joint link mechanism 510 includes a first lever 511 that supports the internal terminal 515, a second lever 512 that is opposed to the first lever 511, and a third lever 513 that couples between the first lever 511 and the second lever 512.

One end of the first lever 511 is coupled to the base plate 60 via a first fulcrum shaft F1. The other end of the first lever 511 is coupled to one end of the third lever 513 via a second fulcrum shaft F2. The first fulcrum shaft F1 and the second fulcrum shaft F2 support the first lever 511 with respect to the base plate 60 and the third lever 513 to be rotatable around the X-axis. The other end of the third lever 513 is coupled to one end of the second lever 512 via a third fulcrum shaft F3. The other end of the second lever 512 is coupled to the base plate 60 via a fourth fulcrum shaft F4. The third fulcrum shaft F3 and the fourth fulcrum shaft F4 support the second lever 512 with respect to the base plate 60 and the third lever 513 to be rotatable around the X-axis.

The elastic member 514 is formed of a torsion spring. The elastic member 514 is supported on a shaft portion 611 provided on the base plate 60. One end of the elastic member 514 is engaged to the base plate 60. The other end of the elastic member 514 is engaged to the first lever 511. The elastic member 514 biases the four-joint link mechanism 510 in a direction to return the internal terminal 515 to the stand-by position.

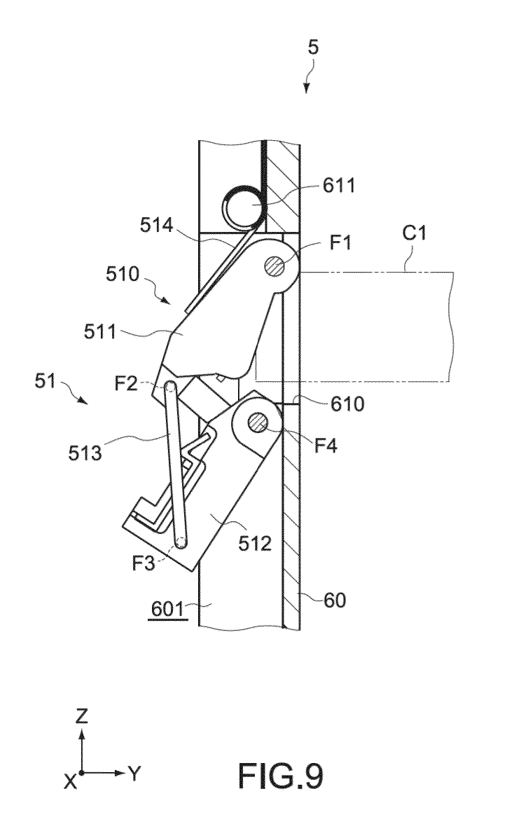

The LAN module 51 configured in the above-mentioned manner takes the first mode shown in FIG. 8 during non-use. Then, the LAN module 51 changes to the second mode shown in FIG. 10 by being pressed by the cable member C1 inserted into the first attachment hole 60a. That is, the four-joint link mechanism 510 is driven (see FIG. 9) due to a pressing action of the cable member C1 with respect to the internal terminal 515. Thus, the internal terminal 515 is moved from the stand-by position shown in FIG. 8 to the attachment position shown in FIG. 10. With this, the cable member C1 is connected to the LAN module 51. Further, the LAN module 51 can automatically return from the second mode to the first mode during detachment of the cable member C1 due to biasing force of the elastic member 514.

### (VGA Module)

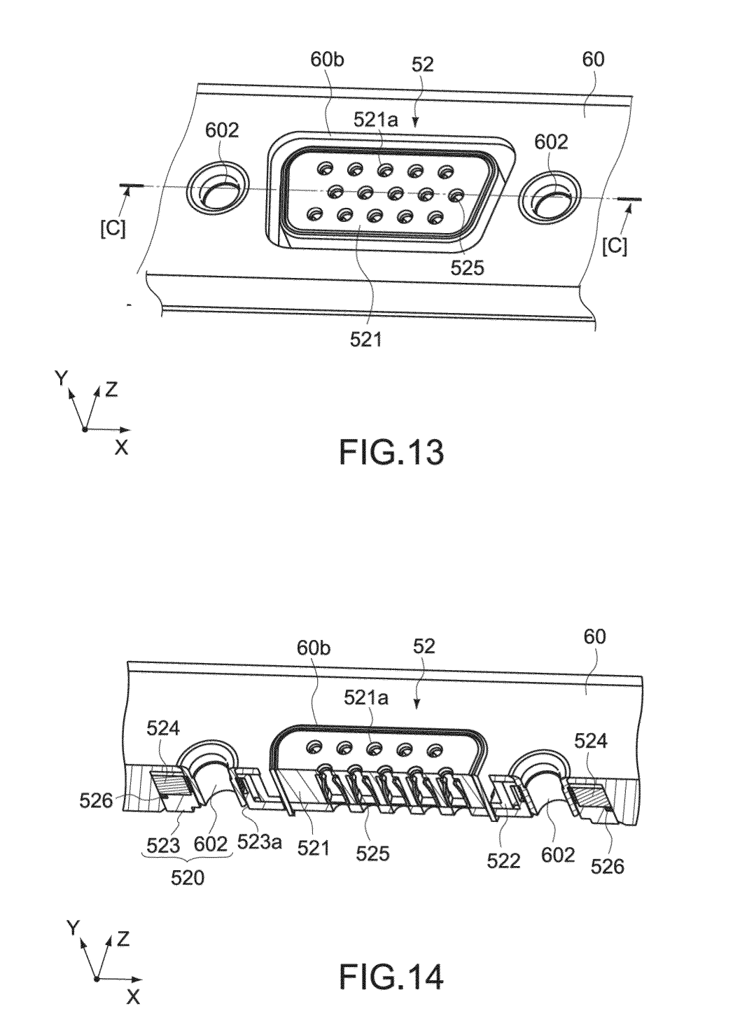

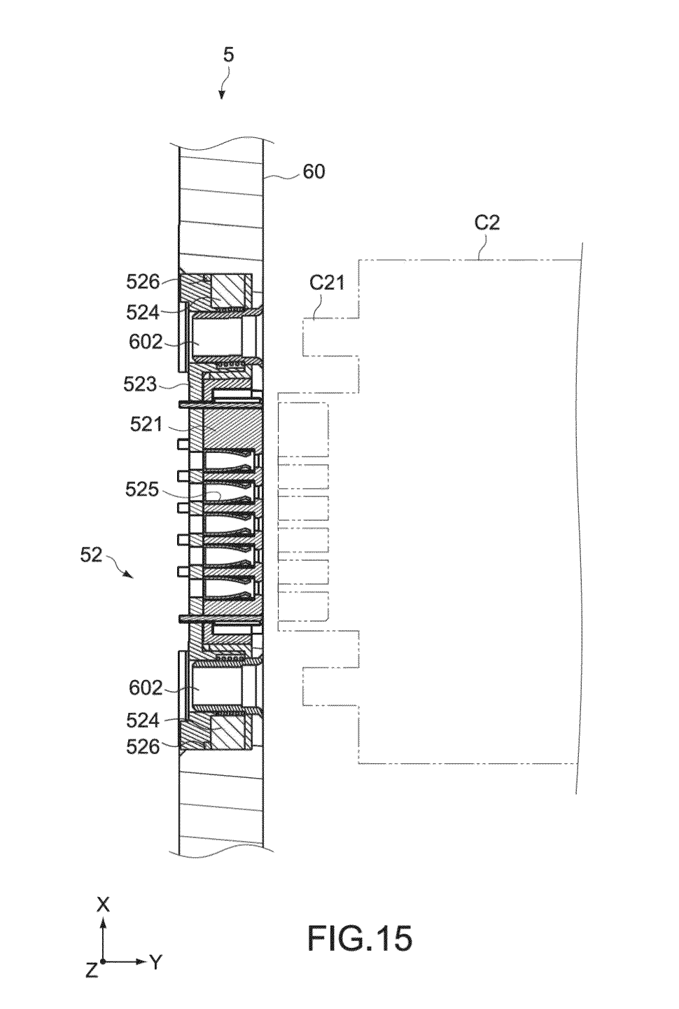

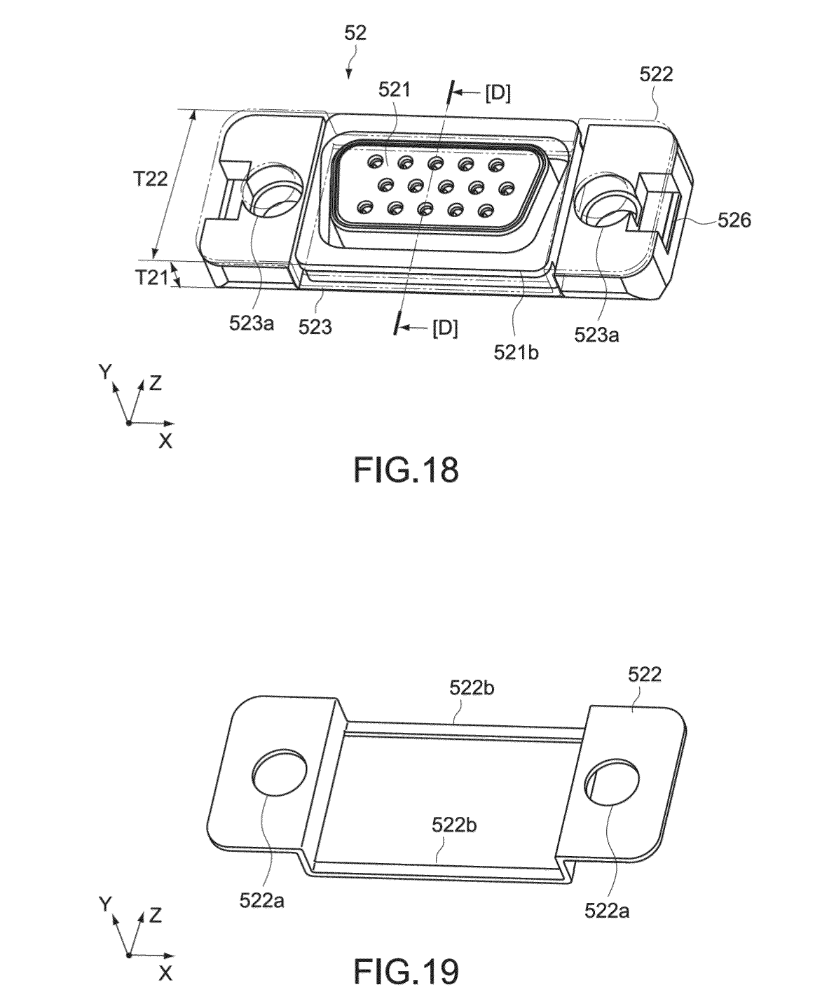

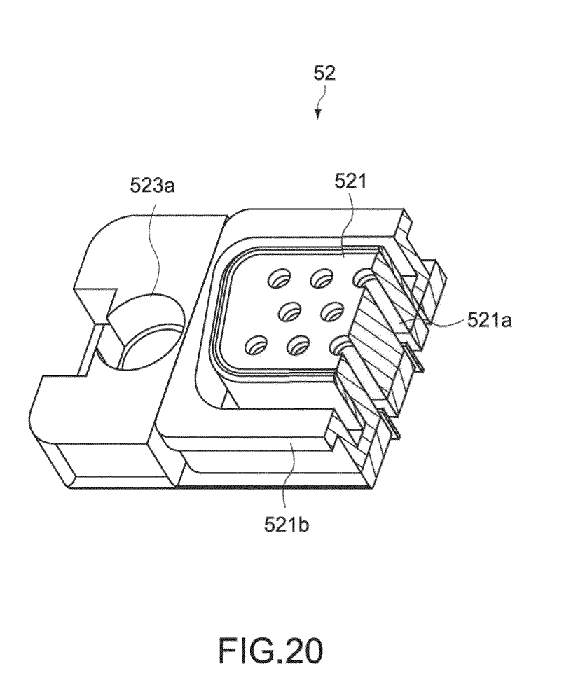

Next, the VGA module 52 will be described. FIG. 13 is a perspective view showing a configuration of the VGA module 52 of the external connection portion 5 that takes the second posture and configurations at the periphery of the VGA module 52. FIG. 14 is a cross-sectional view taken along the line [C]-[C] direction in FIG. 13. FIGS. 15 to 17 are cross-sectional views of main parts showing a mode change before and after connection with the external apparatus of the VGA module 52 that takes the second posture. FIG. 18 is a perspective view of the VGA module 52 alone. FIG. 19 is a perspective view of one member constituting the VGA module 52. FIG. 20 is a cross-sectional view taken along the line [D]-[D] direction in FIG. 18.

As shown in FIG. 13, the VGA module 52 includes a first component size T21 along the Y-axis direction and a second component size T22 along the Z-axis direction. As shown in the figures, T21 is smaller than T22. Further, when the VGA module 52 takes the first posture, T21 becomes a thickness dimension along the Z-axis direction. When the VGA module 52 takes the second posture, T22 becomes a thickness dimension along the Z-axis direction. Therefore, in conjunction with rotation of the display portion 2 from the first state to the second state, the thickness of the VGA module 52 along the Z-axis direction is converted by the conversion mechanism 6 from a first thickness (T21) to a second thickness (T22) larger than the first thickness.

The VGA module 52 is connected to a cable member C2 (external apparatus) via a second attachment hole 60b having a predetermined shape formed in a main surface of the base plate 60. The VGA module 52 includes internal terminals 525, guide mechanisms 520, and biasing members 524.

The internal terminals 525 are provided in a plurality of connection holes 521a formed in a connector 521 made of a synthetic resin. The connector 521 is housed in the second attachment hole 60b having a predetermined shape formed in the base plate 60.

As shown in FIGS. 15 to 17, the connector 521 that supports the internal terminals 525 is configured to be movable between a stand-by position at which the connector 521 is disconnected to the cable member C2 and an attachment position at which the connector 521 is connected to the cable member C2. Here, the stand-by position corresponds to the first mode of the VGA module 52. The attachment position corresponds to the second mode of the VGA module 52. The connector 521 is supported by the guide mechanisms 520. The connector 521 moves from the stand-by position to the attachment position by driving of the guide mechanisms 520.

The guide mechanisms 520 include a supporting member 523 and a pair of tubular portions 602. The supporting member 523 supports the bottom of the connector 521. The supporting member 523 includes through-holes 523a at both ends in the longitudinal direction. The pair of tubular portions 602 are provided to be opposed to each other in the X-axis direction so as to sandwich the connector 521. The pair of tubular portions 602 penetrates into the base plate 60. The pair of tubular portions 602 are inserted into the through-holes 523a of the supporting member 523 to be movable in the Y-axis direction. Screw grooves into which screw members C21 attached to ends of the cable member C2 are screwed are formed in inner peripheral surfaces of the pair of the tubular portions 602.

The biasing members 524 are each formed of a permanent magnet and provided between the base plate 60 and the supporting member 523. At both ends of the supporting member 523, magnetic materials 526 magnetized by the biasing members 524 are attached. The biasing members 524 bias the guide mechanisms 520 in a direction to return the supporting member 523 to the stand-by position due to magnetic force.

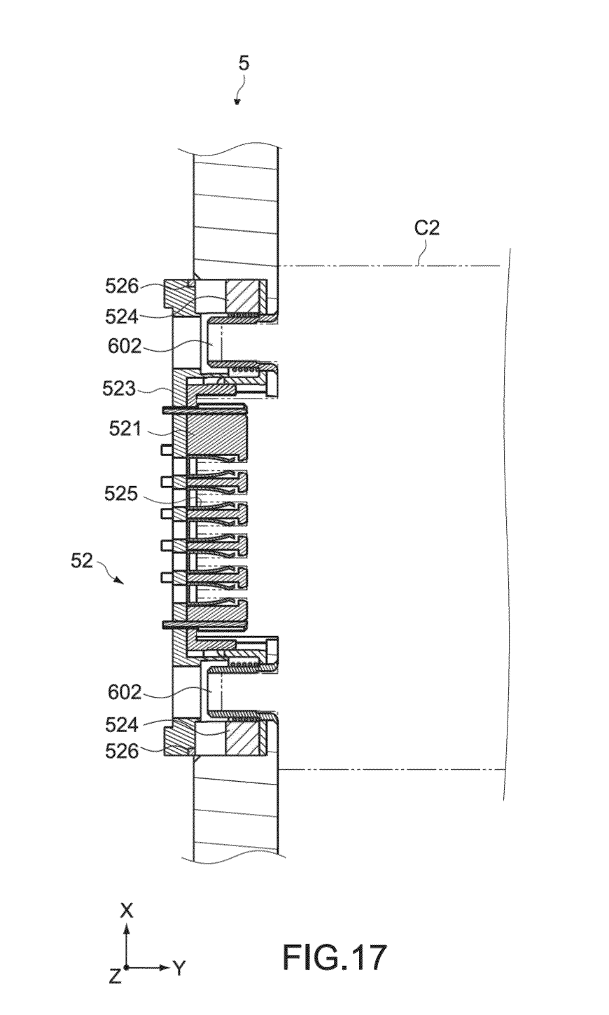

The VGA module 52 further includes a stopper 522 that restricts a movement amount of the connector 521 in the Y-axis direction in FIG. 17. As shown in FIGS. 14, 18, and 19, the stopper 522 is formed of a frame-like member made of metal or a rigid resin. The stopper 522 is provided between the base plate 60 and the supporting member 523. The stopper 522 includes a pair of through-holes 522a inserted into the tubular portions 602 and a pair of frame portions 522b provided between the connector 521 and the supporting member 523. The pair of frame portions 522b are opposed to a pair of flange portions 521b (FIGS. 18 and 20) formed in a rim of the connector 521. As shown in FIG. 17, when the VGA module 52 takes the second mode, the pair of frame portions 522b restrict the movement amount of the connector 521 in the Y-axis direction by abutting against the pair of flange portions 521b.

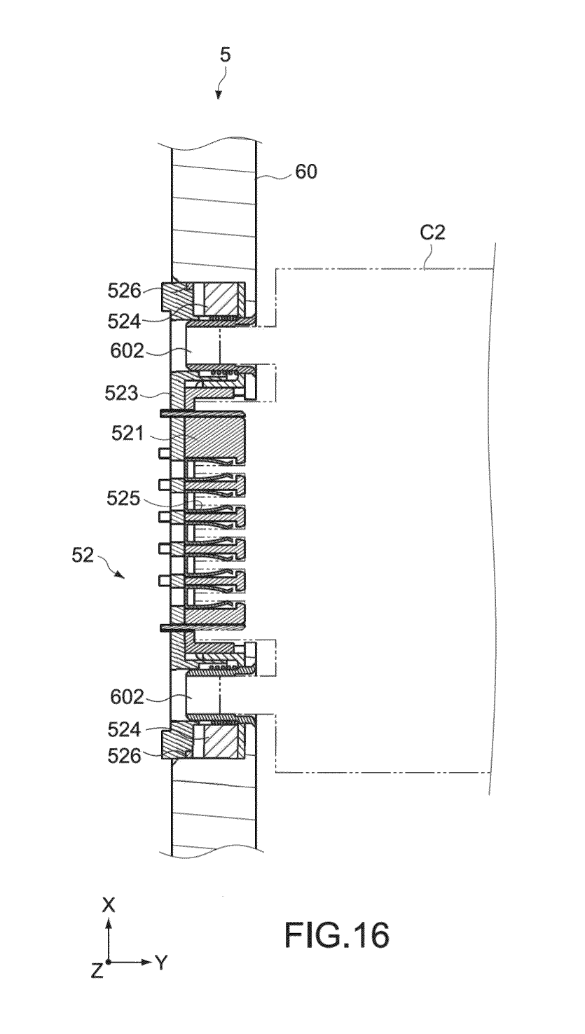

The VGA module 52 configured in the above-mentioned manner takes the first mode shown in FIG. 15 during non-use. Further, the VGA module 52 changes to the second mode shown in FIG. 17 by being pressed by the cable member C2 inserted into the second attachment hole 60b. That is, due to a pressing action of the cable member C2 with respect to the connector 521 (internal terminals 525), the guide mechanisms 520 are driven (see FIG. 16). The connector 521 (internal terminals 525) moves from the stand-by position shown in FIG. 15 to the attachment position shown in FIG. 17. With this, the cable member C2 is connected to the VGA module 52. Further, the VGA module 52 can automatically return from the second mode to the first mode during detachment of the cable member C2 due to biasing force (magnetic force) of the biasing members 524.

### [Operations of Information Processing Apparatus]

The information processing apparatus 1 according to this embodiment configured in the above-mentioned manner includes the first state in which the display portion 2 is closed with respect to the main body portion 3 and the second state in which the display portion 2 is opened with respect to the main body portion 3. The display portion 2 is opened and closed with respect to the main body portion 3 via the hinge portions 4. In conjunction with rotation of a display portion from the first state to the second state, the LAN module 51 and the VGA module 52 are converted from the first thickness (T11, T21) to the second thickness (T12, T22) larger than the first thickness, such that the LAN module 51 and the VGA module 52 can be connected to the external apparatuses (cable members C1 and C2).

Therefore, according to the information processing apparatus 1, the LAN module 51 and the VGA module 52 can be automatically switched to a usable state during a rotation operation of the display portion 2. Thus, a switching operation of each connection module by the user becomes unnecessary. With this, connection operability to the external apparatus can be prevented from being deteriorated. Further, the thickness of the LAN module 51 and the VGA module 52 can be reduced in the first state, and hence a reduction in thickness of the main body portion 3 can be realized.

Further, according to this embodiment, the external connection portion 5 is provided on the back side of the main body portion 3. The degree of freedom of design of a side surface of the main body portion 3 can be increased. Further, as shown in FIG. 4, when the external connection portion 5 takes the second posture, the base plate 60 of the external connection portion 5 is configured to project from the bottom of the main body portion 3 by a predetermined amount. Therefore, when the display portion 2 is opened, the main body portion 3 is automatically tilted up. With this, input operability of the information processing apparatus 1 can be enhanced.

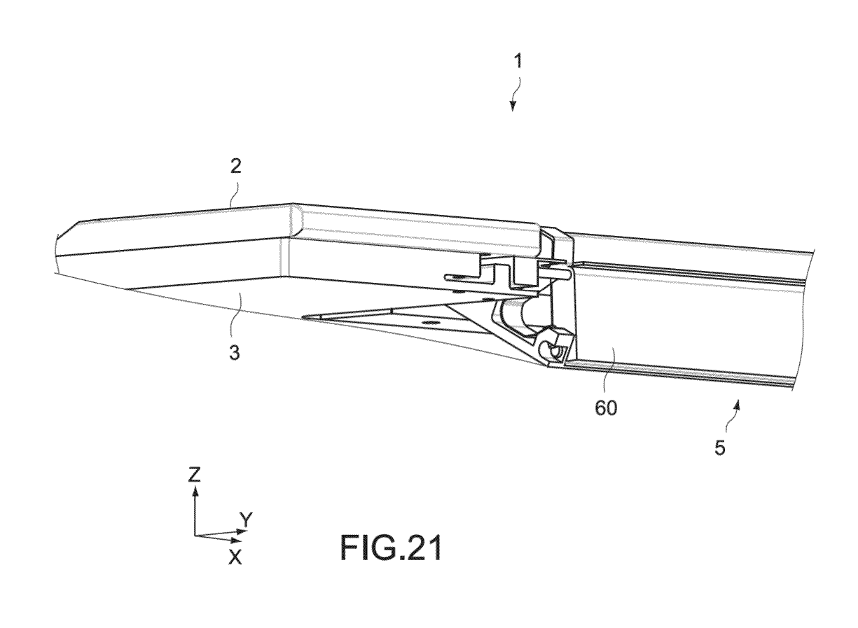

On the other hand, typically, open and close operations of the display portion 2 with respect to the main body portion 3 are manually performed by the user. In this embodiment, posture conversion of the external connection portion 5 from the second posture to the first posture is realized by a rotation operation of the lock-release piece 72 by the user. Therefore, even if the display portion 2 is closed in a state in which the external apparatus is connected to the external connection portion 5, the second posture of the external connection portion 5 can be maintained as shown in FIG. 21. With this, in a state in which the cable members C1 and C2 are connected to the LAN module 51 and the VGA module 52, improper conversion of the external connection portion 5 into the first posture can be suppressed.

Further, according to this embodiment, the LAN module 51 and the VGA module are each configured to be movable between the stand-by position (first mode) and the attachment position (second mode). Therefore, a further reduction of a thickness dimension at the stand-by position can be achieved. That can contribute to a reduction in thickness of the main body portion 3. In addition, when the connection to the external apparatus is released, the LAN module 51 and the VGA module can automatically return from the attachment position to the stand-by position.

Although the embodiment of the present disclosure has been described above, the present disclosure is not limited only to the above embodiment. It is needless to say that various changes can be made without departing from the gist of the present disclosure.

For example, in the above embodiment, the laptop personal computer has been exemplified and described as the information processing apparatus 1. However, the present disclosure is not limited thereto. Also, the present disclosure is applicable also to other electronic apparatuses such as a cell phone, an electronic dictionary, and a portable game console.

Further, in the above embodiment, a plate spring is employed as the transmission member 67 of the conversion mechanism 6. Instead of this, using a link mechanism different from the link mechanism portion 66 or a gear mechanism, a posture conversion operation of the external connection portion 5 may be realized in conjunction with rotation of the display portion 2.

Further, in the above embodiment, the external connection portion 5 is provided on the back side of the main body portion 3. Instead, the external connection portion 5 may be provided on sides of a side surface or a front surface of the main body portion 3.

Further, in the above embodiment, the external connection portion 5 is configured to return from the second posture to the first posture by a rotation operation of the lock-release piece 72. However, the present disclosure is not limited thereto. In conjunction with a rotation operation of the display portion 2 from the second state to the first state, the external connection portion 5 may be configured to automatically return from the second posture to the first posture.

In addition, not only the connection modules 51 and 52 such as the LAN module and the VGA module but also a vent and an illumination component may be further incorporated in the external connection portion 5. With this, the degree of freedom of design of the information processing apparatus can be increased.

It should be noted that the present disclosure may also take the following configurations.

(1) An information processing apparatus, including:

a first casing;

a second casing including a thickness direction along a first axis direction;

a hinge portion configured to connect between the first casing and the second casing and support the first casing with respect to the second casing to be rotatable between a first state in which the hinge portion is opposed to the second casing and a second state in which the hinge portion is rotated around a second axis orthogonal to the first axis direction by a predetermined angle;

at least one connection module that is provided in the second casing and configured to be electrically connectable to an external apparatus in the second state; and

a conversion mechanism that is provided between the first casing and the second casing and configured to convert a thickness of the connection module along the first axis direction from a first thickness into a second thickness larger than the first thickness in conjunction with rotation of the first casing from the first state to the second state.

(2) The information processing apparatus according to Item (1), in which

the connection module is configured to take
a first posture in which the connection module is opposed to the second casing when the connection module has the first thickness, and
a second posture in which the connection module is exposed to an outside of the second casing when the connection module has the second thickness.

(3) The information processing apparatus according to Item (2), in which

the conversion mechanism includes
a link mechanism portion configured to convert the connection module from the first posture into the second posture, and
a transmission member that is provided between the first casing and the link mechanism portion and configured to transmit rotation operation force of the first casing from the first state to the second state.

(4) The information processing apparatus according to Item (3), in which

the link mechanism portion includes
a base plate that includes a first fulcrum coupled to the second casing and is configured to support the connection module,
a coupling plate that includes
   a second fulcrum coupled to the second casing, and
   a third fulcrum coupled to the base plate, and
a guide portion that is attached to the second casing and configured to guide a movement of the first fulcrum relative to the second fulcrum during conversion from the first posture to the second posture.

(5) The information processing apparatus according to Item (4), in which

the conversion mechanism further includes
a lock member that is attached to the second casing and configured to be capable of retaining the first fulcrum in the second posture, and
a return member that is attached between the first fulcrum and the second fulcrum and is configured to bias the connection module in a direction to return the connection module to the first posture.

(6) The information processing apparatus according to any one of Items (2) to (5), in which

the second casing includes a housing portion capable of housing the connection module, and

the connection module is configured to be opposed to an inner surface of the housing portion when the connection module takes the first posture, and exposed to an outside of the housing portion when the connection module takes the second posture.

(7) The information processing apparatus according to Item (6), in which

the second casing includes a back portion to be connected to the hinge portion, and

the housing portion is provided to the back portion.

(8) The information processing apparatus according to any one of Items (1) to (7), in which

the connection module includes a local area network (LAN) module.

(9) The information processing apparatus according to Item (8), in which

the connection module includes
an internal terminal configured to be movable between a stand-by position at which the internal terminal is disconnected to the external apparatus and an attachment position at which the internal terminal is connected to the external apparatus,
a four-joint link mechanism configured to be connected to the connection module by being pressed by the external apparatus, such that the internal terminal moves from the stand-by position to the attachment position, and

an elastic member configured to bias the four-joint link mechanism in a direction to return the internal terminal to the stand-by position.

(10) The information processing apparatus according to any one of Items (1) to (9), in which

the connection module includes a video graphics array (VGA) module.

(11) The information processing apparatus according to Item (10), in which

the connection module includes
an internal terminal configured to be movable between a stand-by position at which the internal terminal is disconnected to the external apparatus and an attachment position at which the internal terminal is connected to the external apparatus,
a guide mechanism configured to be connected to the connection module by being pressed by the external apparatus, such that the internal terminal moves from the stand-by position to the attachment position, and
a biasing member configured to bias the guide mechanism in a direction to return the internal terminal to the stand-by position.

(12) The information processing apparatus according to any one of Items (1) to (11), further including

a screen provided in the first casing, and

an input operation surface provided in the second casing.

The present disclosure contains subject matter related to that disclosed in Japanese Priority Patent Application JP 2012-112072 filed in the Japan Patent Office on May 16, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a first casing;
a second casing including a thickness direction along a first axis direction;
a hinge portion configured to connect between the first casing and the second casing and support the first casing with respect to the second casing to be rotatable between a first state in which the hinge portion is opposed to the second casing and a second state in which the hinge portion is rotated around a second axis orthogonal to the first axis direction by a predetermined angle;
at least one connection module that is provided in the second casing and configured to be electrically connectable to an external apparatus in the second state; and
a conversion mechanism that is provided between the first casing and the second casing and configured to convert a thickness of the connection module along the first axis direction from a first thickness into a second thickness larger than the first thickness in conjunction with rotation of the first casing from the first state to the second state.

2. The information processing apparatus according to claim 1, wherein
the connection module is configured to take
a first posture in which the connection module is opposed to the second casing when the connection module has the first thickness, and
a second posture in which the connection module is exposed to an outside of the second casing when the connection module has the second thickness.

3. The information processing apparatus according to claim 2, wherein
the conversion mechanism includes
a link mechanism portion configured to convert the connection module from the first posture into the second posture, and
a transmission member that is provided between the first casing and the link mechanism portion and configured to transmit rotation operation force of the first casing from the first state to the second state.

4. The information processing apparatus according to claim 3, wherein
the link mechanism portion includes
a base plate that includes a first fulcrum coupled to the second casing and is configured to support the connection module,
a coupling plate that includes
a second fulcrum coupled to the second casing, and
a third fulcrum coupled to the base plate, and
a guide portion that is attached to the second casing and configured to guide a movement of the first fulcrum relative to the second fulcrum during conversion from the first posture to the second posture.

5. The information processing apparatus according to claim 4, wherein
the conversion mechanism further includes
a lock member that is attached to the second casing and configured to be capable of retaining the first fulcrum in the second posture, and
a return member that is attached between the first fulcrum and the second fulcrum and is configured to bias the connection module in a direction to return the connection module to the first posture.

6. The information processing apparatus according to claim 2, wherein
the second casing includes a housing portion capable of housing the connection module, and
the connection module is configured to be opposed to an inner surface of the housing portion when the connection module takes the first posture, and exposed to an outside of the housing portion when the connection module takes the second posture.

7. The information processing apparatus according to claim 6, wherein
the second casing includes a back portion to be connected to the hinge portion, and
the housing portion is provided to the back portion.

8. The information processing apparatus according to claim 1, wherein
the connection module includes a local area network (LAN) module.

9. The information processing apparatus according to claim 8, wherein
the connection module includes
an internal terminal configured to be movable between a stand-by position at which the internal terminal is disconnected to the external apparatus and an attachment position at which the internal terminal is connected to the external apparatus,
a four-joint link mechanism configured to be connected to the connection module by being pressed by the external apparatus, such that the internal terminal moves from the stand-by position to the attachment position, and
an elastic member configured to bias the four-joint link mechanism in a direction to return the internal terminal to the stand-by position.

10. The information processing apparatus according to claim 1, wherein
the connection module includes a video graphics array (VGA) module.

11. The information processing apparatus according to claim 10, wherein
the connection module includes
an internal terminal configured to be movable between a stand-by position at which the internal terminal is disconnected to the external apparatus and an attachment position at which the internal terminal is connected to the external apparatus,
a guide mechanism configured to be connected to the connection module by being pressed by the external apparatus, such that the internal terminal moves from the stand-by position to the attachment position, and
a biasing member configured to bias the guide mechanism in a direction to return the internal terminal to the stand-by position.

12. The information processing apparatus according to claim 1, further comprising
a screen provided in the first casing, and
an input operation surface provided in the second casing.
